(19) United States
(12) Patent Application Publication
(10) Pub. No.: US 2023/0101508 A1
(43) Pub. Date: Mar. 30, 2023

(54) MULTI-FUNCTIONAL, T-POST PULLER TOOL FOR PERFORMING TASKS RELATED TO OUTDOOR FENCING, TREE PLANTING, RANCHING, FARMING, HOUSE FIXING, AND THE LIKE

(71) Applicant: Jeffrey Lynn Nice, Reeds, MO (US)

(72) Inventor: Jeffrey Lynn Nice, Reeds, MO (US)

(21) Appl. No.: 17/855,789

(22) Filed: Jun. 30, 2022

Related U.S. Application Data
(60) Provisional application No. 63/248,150, filed on Sep. 24, 2021.

(51) Int. Cl. E04H 17/26; B25C 11/00

(52) U.S. Cl. CPC E04H 17/265; B25C 11/00; E04H 17/268

(57) ABSTRACT

The present invention is a multi-functional, T-post puller tool for performing tasks related to outdoor fencing, tree planting, ranching, farming, house fixing, and the like. The multi-functional tool includes some, many, most or all of the following: a wire holder; a bubble level; a T-post pulling guide hole; a pulling hook/chain hole; a wedge; a magnet; a wire hook; and an insulator guide. In a non-limiting, preferred embodiment, the multi-functional tool is a rectangular-shaped plate or card that includes a first end, a second end, a first or front side, a second or rear side, and a pair of edges or sidewalls. The rectangular-shaped plate or card further includes some, many, most or all of the following: a wire holder; a bubble level; a T-post pulling guide hole; a pulling hook/chain hole; a wedge; a magnet; a wire hook; and an insulator guide.

### CROSS-REFERENCE TO RELATED APPLICATIONS

The present application claims the priority benefit of U.S. Provisional Patent Application Ser. No. 63/248,150, filed on Sep. 24, 2021 and titled “MULTI-FUNCTIONAL, T-POST PULLER TOOL FOR OUTDOOR FENCING, TREE PLANTING WORK, AND THE LIKE,” which is incorporated herein by reference in its entirety.

### BACKGROUND OF THE INVENTION

### Field of the Invention

The present invention generally relates to tools, devices, apparatuses, and systems for performing tasks related to outdoor fencing, tree planting, ranching, farming, house fixing, and the like. More specifically, the present invention is a multi-functional, T-post puller tool for performing tasks related to outdoor fencing, tree planting, ranching, farming, house fixing, and the like.

### Description of the Related Art

Tools, devices, apparatuses, and systems for performing tasks related to outdoor fencing, tree planting, ranching, farming, house fixing, and the like are known in the art.

The present invention overcomes one or more of the shortcomings of tools, devices, apparatuses, and systems for performing tasks related to outdoor fencing, tree planting, ranching, farming, house fixing, and the like. The Applicant is unaware of inventions or patent documents, taken either singly or in combination, which are seen to describe the present invention as claimed.

An advantage of the multi-functional, T-post puller tool of the present invention is that it is a single tool that can perform multiple tasks related to outdoor fencing, tree planting, ranching, farming, house fixing, and the like.

Another advantage of the multi-functional, T-post puller tool of the present invention is that it is a relatively compact tool that can perform multiple tasks related to outdoor fencing, tree planting, ranching, farming, house fixing, and the like.

A further advantage of the multi-functional, T-post puller tool of the present invention is that it is relatively lightweight tool that can perform multiple tasks related to outdoor fencing, tree planting, ranching, farming, house fixing, and the like.

### SUMMARY OF THE INVENTION

The present invention is a multi-functional, T-post puller tool for performing tasks related to outdoor fencing, tree planting, ranching, farming, house fixing, and the like. The multi-functional tool comprises some, many, most or all of the following: a wire holder; a bubble level; a T-post pulling guide hole; a pulling hook/chain hole; a wedge; a magnet; a wire hook; and an insulator guide.

In a non-limiting, preferred embodiment, the multi-functional tool is a rectangular-shaped plate or card comprising a first end, a second end, a first or front side, a second or rear side, and a pair of edges or sidewalls. The rectangular-shaped plate or card further comprises some, many, most or all of the following: a wire holder; a bubble level; a T-post pulling guide hole; a pulling hook/chain hole; a wedge; a magnet; a wire hook; and an insulator guide.

### BRIEF DESCRIPTION OF THE DRAWINGS

FIG. 1 is a front view of an embodiment of a multi-functional, T-post puller tool according to the present invention;

FIG. 2 is a perspective, rear, left side view of the multi-functional, T-post puller tool of FIG. 1;

FIG. 3 is an environmental, perspective, rear, left side view of the multi-functional, T-post puller tool of FIG. 1, showing a non-limiting example of wire twisting;

FIG. 4 is an environmental, perspective, rear, left side view of the multi-functional, T-post puller tool of FIG. 1, showing a non-limiting example of T-post pulling;

FIG. 5 is an environmental, top view of the multi-functional, T-post puller tool of FIG. 1, showing a non-limiting example of removing wire insulator;

FIG. 6 is a perspective, front view of another embodiment of a multi-functional, T-post puller tool according to the present invention;

FIG. 7 is a perspective, rear, left side view of the multi-functional, T-post puller tool of FIG. FIG. 6;

FIG. 8 is an environmental, perspective, rear, left side view of the multi-functional, T-post puller tool of FIG. 6, showing a non-limiting example of wire twisting;

FIG. 9 is an environmental, perspective, rear, left side view of the multi-functional, T-post puller tool of FIG. 6, showing a non-limiting example of T-post pulling; and

FIG. 10 is an environmental, top view of the multi-functional, T-post puller tool of FIG. 6, showing a non-limiting example of removing wire insulator.

It should be understood that the above-attached figures are not intended to limit the scope of the present invention in any way.

### DETAILED DESCRIPTION OF THE EMBODIMENTS OF THE PRESENT INVENTION

The present invention is a multi-functional, T-post puller tool 100,200 for performing tasks related to outdoor fencing, tree planting, ranching, farming, house fixing, and the like. The multi-functional tool 100,200 comprises some, many, most or all of the following: a wire holder 110,210; a bubble level 120,220; a T-post pulling guide hole 130, 230; a pulling hook/chain hole 140,240; a wedge 150,250; a magnet 160,260; a wire hook 170,270; and an insulator guide 180,280.

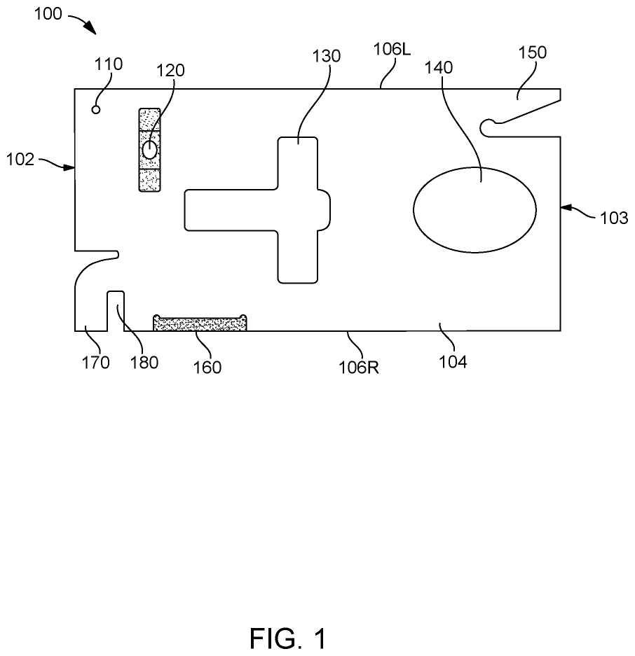

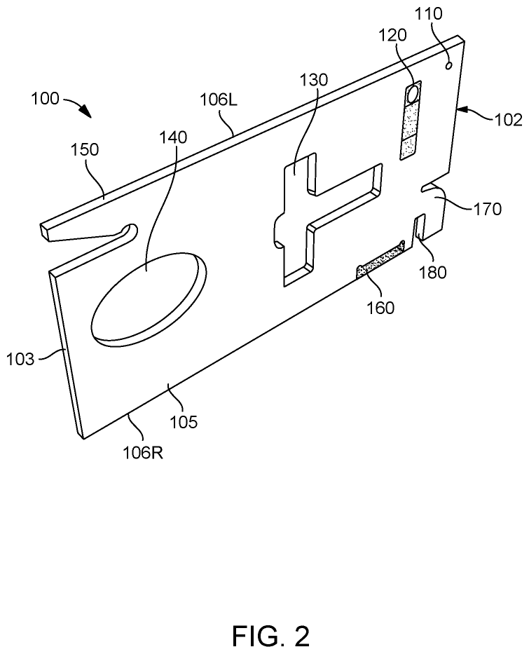

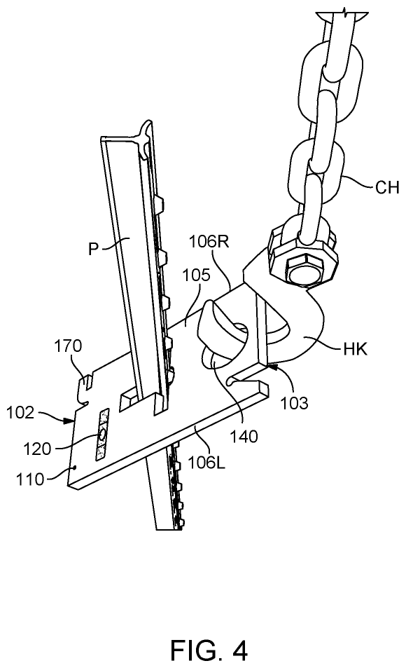

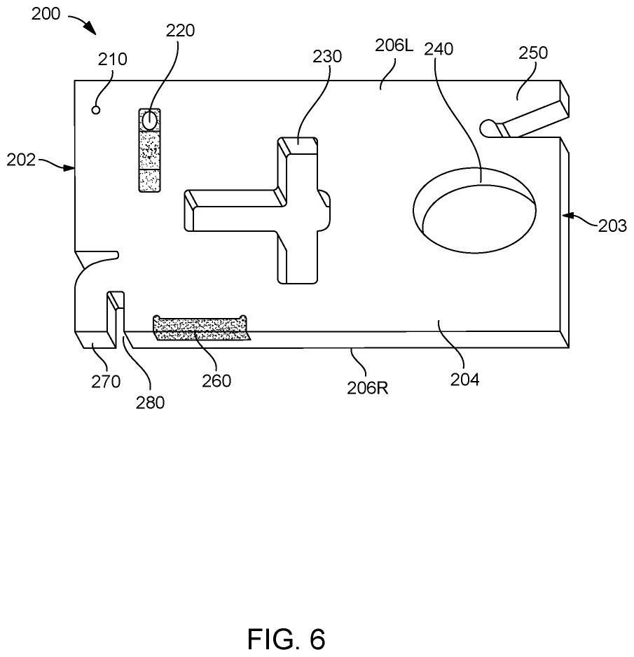

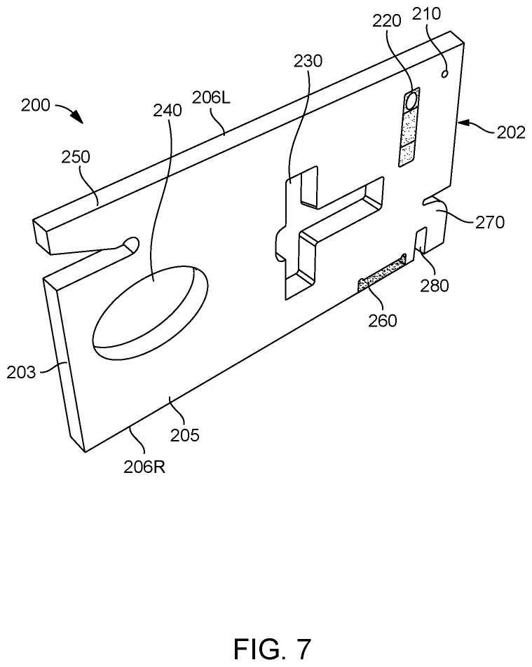

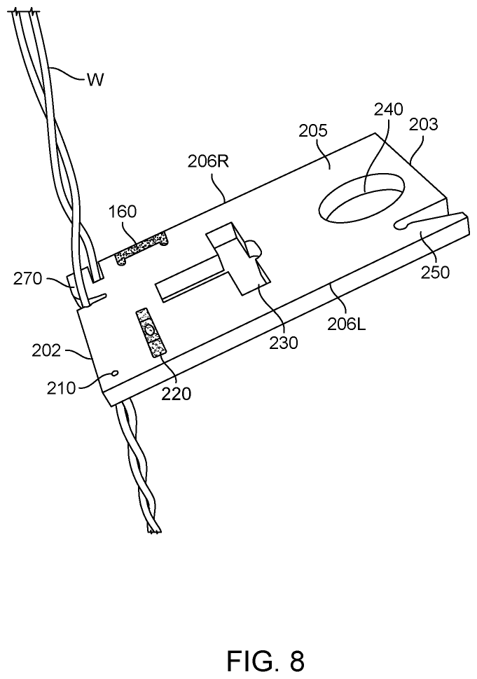

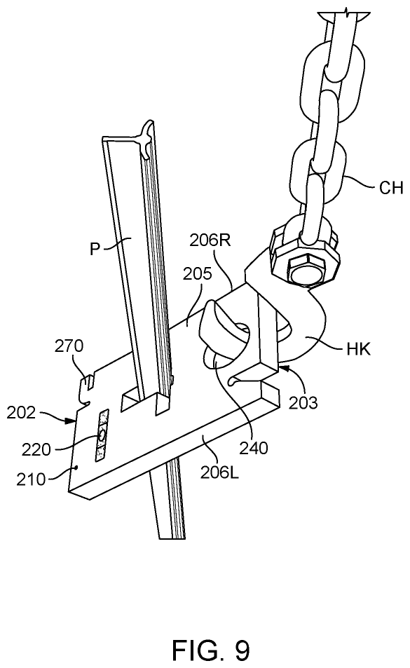

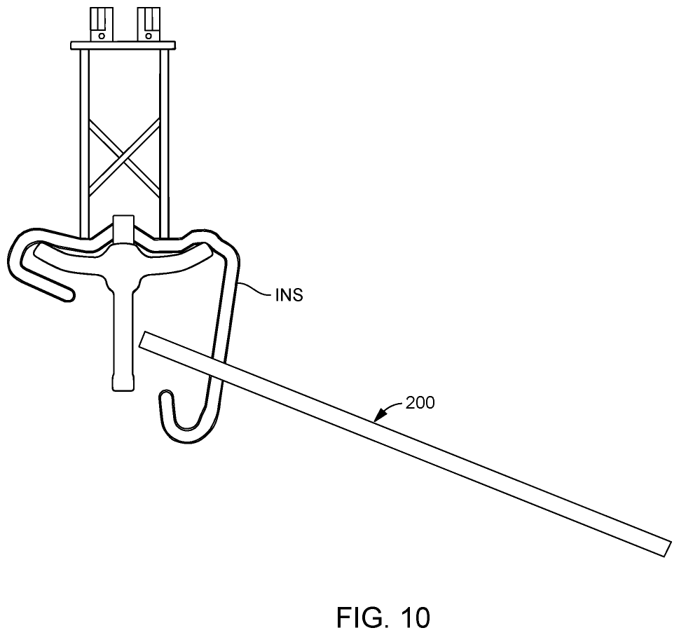

In non-limiting, preferred embodiments and as shown in FIGS. 1-10, the multi-functional tool 100,200 is a rectangular-shaped plate or card 100,200 comprising a first or top end 102,202, a second or bottom end 103,203, a first or front side 104,204, a second or rear side 105,205, and a pair of edges or sidewalls 106R,106L,206R,206L. The rectangular-shaped plate or card 100,200 further comprises some, many, most or all of the following: a wire holder 110,210; a bubble level 120,220; a T-post pulling guide hole 130,230; a pulling hook/chain hole 140,240; a wedge 150,250; a magnet 160,260; a wire hook 170,270; and an insulator guide 180,280. Preferably, the rectangular-shaped plate or card 100,200 has a sufficient thickness and a sufficient length, and is dimensioned and configured for being gripped or held by a user during use. Preferably, the rectangular-shaped plate or card 100,200 has a sufficient thickness and a sufficient strength that prevents it from being damaged, such as, but not limited to, breaking, bending, warping, twisting, and the like under normal usage. The multi-functional, T-post puller tool 100,200 may also be configured in another shape (in the form of a partial shape, a semi shape, or a full shape), such as, but not limited to, a square, an oval, a circle, a triangle, any other shape known to one of ordinary skill in the art, or any combination thereof.

Preferably, each of the front side 104,204 and rear side 105,205 of the rectangular-shaped plate or card 100,200 is generally planar.

The wire holder 110,210 is dimensioned and configured for being slid over a wire retaining clip(s) that is/are installed to hold the smooth, barbed, or non-barbed wire in place against a T-post.

The bubble level 120,220 is adapted for or capable of indicating whether a surface is horizontal (level) or vertical (plumb). The bubble level 120, 220 may be any bubble level known to one of ordinary skill in the art.

The T-post pulling guide hole 130,230 is dimensioned and configured for performing as a T-post pulling guide. The configuration of the T-post pulling guide hole 130,230 allows for T-posts that have nubs or no longer have full nubs or nubs at all to be pulled. The configuration of the T-post pulling guide hole 130,230 also works for pulling (or pulling out from ground, wall, or other structures) ground rods, survey stakes, coaxial cables, electrical cables, etc.

The pulling hook/chain hole 140,240 is dimensioned and configured for receiving a pulling hook HK, a pulling chain CH, and the like.

The wedge 150,250 is dimensioned and configured for removing wood post staples and the like. Preferably, the wedge 150,250 is located about a corner of the multi-functional, T-post puller tool 100,200.

The magnet 160,260 is for attaching the multi-functional, T-post puller tool 100,200 to a metal post and the like.

The wire hook 170,270 is dimensioned and configured for twisting guide and brace wires W and the like for proper tensioning.

The insulator guide 180,280 is dimensioned and configured for performing as an insulator guide. As a non-limiting example, the insulator guide 180,280 is about a half an inch from the edge and end of the tool 100,200, and the slit of the insulator guide 180,280 is about one quarter of an inch wide.

As a non-limiting example, a use of the multi-functional, T-post puller tool 100,200 is to pull or pull up T-posts that have been driven deep in the ground, clay, rock, and the like. This multi-functional tool 100,200 is able to grab the T-post at multiple points so it eliminates many pinching points compared to many or all other T-post pullers that rely solely on gripping the small nub (“studs” or “nubs”—“The studs or nubs along the post are specially designed for preventing the fencing wire slipping up and down https://www.starpickets.com/starpickets/studded-t-post-usa.html) on the front of the T-post. The multi-functional tool 100,200 will grab hold of the post at about five to six points as soon as upward pressure is applied to the multi-functional tool 100,200. The multi-functional tool 100,200 is capable of pulling or pulling up T-posts with the multi-functional tool 100,200 grabbing only the top inch or two of the T-post. The multi-functional tool 100,200 is also capable of pulling or pulling up eight foot copper electrical grounding rods, long pieces of rebar, all thread and bolts as long as the multi-functional tool 100,200 can be slid over the end of the material to grip it.

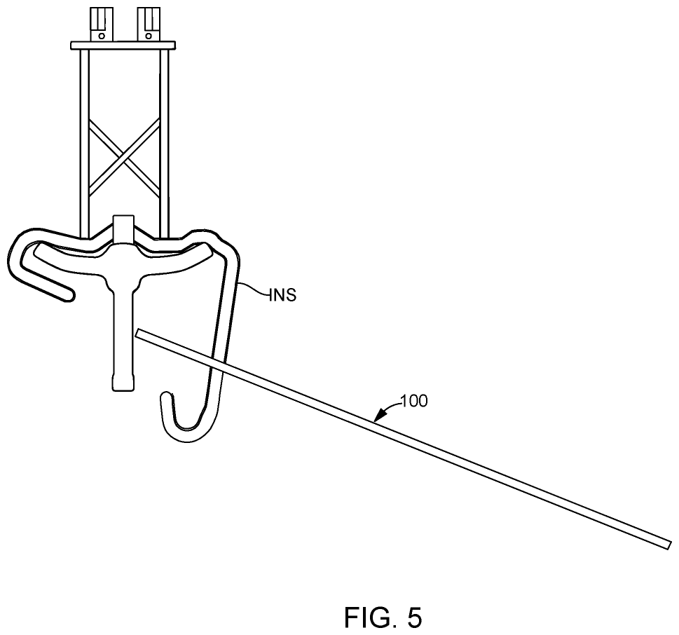

The T-post pulling guide hole 130,230 and pulling hook/chain hole 140,240 are key parts of this multi-functional tool 100,200 for removing T-posts, electrical grounding rods, survey stakes, and rebar that are driven several feet into the ground. In use, the multi-functional tool 100,200 can be slid over the T-post or rod attached by use of a chain CH and hook HK it to a tractor, a skid steer front loader, and the like to easily pull the T-post or rod from the ground. Most metal shelter manufacturers use rebar driven three to four feet into the ground through the shelter frame to keep the structure from blowing away in gusty winds. Without a tool to properly grab the rod, a chain will just slip and slide right off the top of the rod. The multi-functional tool 100,200 is able to grab the rod at multiple points so the rod can be easily pulled or pulled up from the ground and frame of the shelter. As shown in FIG. 5, the multi-functional tool 100,200 may be used the same way for rods and rebar as it is used on T-posts. Electricians and utility companies may find that the multi-functional tool 100,200 works very well to pulling large aluminum/copper/coaxial cables off of their large spools as well.

Another non-limiting function of the multi-functional tool 100,200 is helping property owners, farm operators and fencing professionals install and/or remove electric fence insulators. Plastic insulators INS are used on electric fences to keep the positively-charged wire from shorting out (or grounding out) against the negatively-charged metal T-post (as shown in FIG. 5). Installed new, plastic insulators are stiff and difficult to attach to the T-post. After being exposed to the daily summer sun, they lose elasticity, and thus, makes them very difficult to remove from the T-post. Held sideways, this multi-functional tool 100,200 slides down the T-post spine until the multi-functional tool 100,200 slides over the insulator hook making it easier to break the grip of the plastic insulator to the T-post. With very little pressure backward and forward to install and/or remove the insulator, the multi-functional tool 100,200 breaks the lock the insulator has on the T-post spine. The length of the multi-functional tool 100,200 provides significant leverage to the user for quickly and easily installing and/or removing the insulators even if a person is handicapped by arthritis in their hands and fingers. The multi-functional tool 100,200 can also be used for holding and/or bending the wire retaining clips that secure smooth, barbed or tensile wire flat against the face of the T-post between the nubs. By sliding the end of the wire retaining clips through the hole, then pushing and/or pulling against the fence wire the multi-functional tool 100,200 bends the wire retaining clip so it can be installed and/or removed without pinching the user's fingers wrestling with large fencing pliers. The wire retaining clips can be seen in the picture with the T-posts at this web address: https://www.starpickets.com/starpickets/studded-t-post-usa.html. The multi-functional tool 100,200 grips the wire so the user can quickly and easily remove the retaining clip unlike the normal pliers method that requires grabbing the wire with excessive hand strength to grip and wrestle with the wire clip that releases the wire fencing from the T-post. The multi-functional tool 100,200 uses geometry and leverage to make the job of assembling and/or disassembling fence easier and significantly faster.

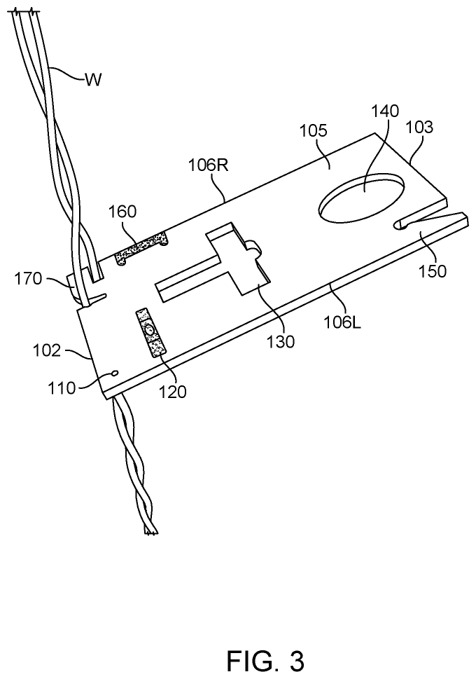

The built-in, bubble level 120,220 is capable of showing the user visually when the T-post or newly planted tree is properly positioned perpendicular to the ground. The embedded magnet 160,260 holds the multi-functional tool 100,200 in place against the T-post spine while the user is monitoring the bubble level 120,220 for proper positioning and/or attaching insulators, fencing wire, retaining clips, and the like. Fencing staples can be removed by hammering the wedge 150,250 into them with a hammer. The slope of the wedge 150,250 lifts the fencing staples out of the wood corner or line posts so wood posts can be easily replaced or let the wire fence down to the ground to drive livestock back into a particular pasture after their unscheduled escape. The fencing staples are usually driven too deep into the wood post for a hammer to lift the wire and fencing staple out of the post. After the wedge 150,250 is properly lined up perpendicular to the fencing staple, the user strikes the end of the multi-functional tool 100,200 to drive the tip of the wedge 150,250 under the wire fence and staple that lifts the fencing staple out of the post as the user continues to strike the multi-functional tool 100,200 with a hammer on the opposite end of the multi-functional tool 100,200. About ten to fifteen strikes with a hammer is usually sufficient. The wire hook 170,270 is used for twisting guide wire W on newly planted trees and applying tension to H brace corner posts when building fence. Twisting of the cables tightens or loosens the heavy gauge wire W designed to hold firm the tree and wood posts (as shown in FIG. 3). Without strong wire tension applied to wood corner post brace wire (H brace example: https://www.progressivecattle.com/topics/facilities-equipment/4-steps-to-construct-a-long-lasting-h-brace), the posts begin to shift and move in the ground under the extreme weight and tension of multiple strands of (half mile long) wire pulling the posts this way or that. The wire fence will quickly sag which allows livestock to simply step over the wire fence and cause accidents on roadways. Even if its barbed wire, livestock will put pressure on the fence to reach the grass on the other side.

As a non-limiting example, the multi-functional, T-post puller tool may be similar to the multi-functional, T-post puller tool 100,200, and preferably comprises at least the pulling hook/chain hole 140,240, which is dimensioned and configured for gripping whatever, such as, but not limited to, a pulling hook, a pulling chain, and the like, you are trying to pull. In this non-limiting example, the multi-functional, T-post puller tool may further comprise one (the T-post pulling guide hole 130,230), some or all of the other components of the multi-functional, T-post puller tool 100,200.

As another non-limiting example, the multi-functional, T-post puller tool may be similar to the multi-functional, T-post puller tool 100,200, and preferably comprises at least the insulator guide 180,280, which is dimensioned and configured for performing as an insulator guide. In this non-limiting example, the multi-functional, T-post puller tool may further comprise one (the wire hook 170,270), some or all of the other components of the multi-functional, T-post puller tool 100,200.

Preferably, the multi-functional tool 100,200 is made or manufactured of a metal material, aluminum, a plastic material, a wood material, and any combination thereof. Preferably, the multi-functional tool 100,200 is made or manufactured of a rustproof or rust-resistant material.

Preferably, the multi-functional tool 100,200 is made or manufactured of a lightweight material.

It is to be understood that the present invention is not limited to the embodiments described above or as shown in the attached figures, but encompasses any and all embodiments within the spirit of the invention.

1. A multi-functional, T-post puller tool comprising a pulling hook/chain hole dimensioned and configured for receiving a pulling device and allowing said multi-functional, T-post puller tool to grip the pulling device.

2. The multi-functional, T-post puller tool according to claim 1, wherein said multi-functional, T-post puller tool has a rectangular-shaped plate or card configuration that comprises a first end, a second end, a first or front side, a second or rear side, and a pair of edges or sidewalls.

3. The multi-functional, T-post puller tool according to claim 1, wherein said multi-functional, T-post puller tool is made or manufactured of a material selected from the group consisting of metal material, aluminum, a plastic material, a wood material, and any combination thereof.

4. The multi-functional, T-post puller tool according to claim 1, wherein said multi-functional, T-post puller tool is made or manufactured of a rustproof or rust-resistant material.

5. The multi-functional, T-post puller tool according to claim 1, wherein the pulling device is selected from the group consisting of a pulling hook, a pulling chain, and the like.

6. The multi-functional, T-post puller tool according to claim 1, further comprising a T-post pulling guide hole dimensioned and configured for performing as a T-post pulling guide.

7. The multi-functional, T-post puller tool according to claim 6, further comprising at least one selected from the group consisting of a wire holder, a bubble level, a wedge, a magnet, a wire hook, and an insulator guide, wherein said wedge is dimensioned and configured for removing wood post staples and the like, wherein said insulator guide is dimensioned and configured for performing as an insulator guide, and wherein said insulator guide comprises a slit.

8. The multi-functional, T-post puller tool according to claim 1, further comprising a T-post pulling guide hole, a wire holder, a bubble level, a wedge, a magnet, a wire hook, and an insulator guide, wherein said T-post pulling guide hole is dimensioned and configured for performing as a T-post pulling guide, wherein said wedge is dimensioned and configured for removing wood post staples and the like, wherein said insulator guide is dimensioned and configured for performing as an insulator guide, and wherein said insulator guide comprises a slit.

9. A multi-functional, T-post puller tool comprising an insulator guide dimensioned and configured for performing as an insulator guide, wherein said insulator guide comprises a slit.

10. The multi-functional, T-post puller tool according to claim 9, wherein said multi-functional, T-post puller tool has a rectangular-shaped plate or card configuration that comprises a first end, a second end, a first or front side, a second or rear side, and a pair of edges or sidewalls.

11. The multi-functional, T-post puller tool according to claim 9, wherein said multi-functional, T-post puller tool is made or manufactured of a material selected from the group consisting of metal material, aluminum, a plastic material, a wood material, and any combination thereof.

12. The multi-functional, T-post puller tool according to claim 9, wherein said multi-functional, T-post puller tool is made or manufactured of a rustproof or rust-resistant material.

13. The multi-functional, T-post puller tool according to claim 9, wherein said insulator guide is about a half an inch from an edge and an end of said multi-functional, T-post puller tool, and wherein said slit is about one quarter of an inch wide.

14. The multi-functional, T-post puller tool according to claim 9, further comprising a wire hook.

15. The multi-functional, T-post puller tool according to claim 14, further comprising at least one selected from the group consisting of a pulling hook/chain hole, a T-post pulling guide hole, a wire holder, a bubble level, a wedge, a magnet, wherein said T-post pulling guide hole is dimensioned and configured for performing as a T-post pulling guide, wherein said wedge is dimensioned and configured for removing wood post staples and the like, and wherein said pulling hook/chain hole is dimensioned and configured for receiving a pulling device and allowing said multi-functional, T-post puller tool to grip the pulling device.

16. A multi-functional, T-post puller tool comprising a wedge dimensioned and configured for removing wood post staples and the like.

17. The multi-functional, T-post puller tool according to claim 16, wherein said multi-functional, T-post puller tool has a rectangular-shaped plate or card configuration that comprises a first end, a second end, a first or front side, a second or rear side, and a pair of edges or sidewalls.

18. The multi-functional, T-post puller tool according to claim 16, wherein said multi-functional, T-post puller tool is made or manufactured of a material selected from the group consisting of metal material, aluminum, a plastic material, a wood material, and any combination thereof.

19. The multi-functional, T-post puller tool according to claim 16, wherein said multi-functional, T-post puller tool is made or manufactured of a rustproof or rust-resistant material.

20. The multi-functional, T-post puller tool according to claim 16, further comprising a pulling hook/chain hole and an insulator guide, wherein said pulling hook/chain hole is dimensioned and configured for receiving a pulling device and allowing said multi-functional, T-post puller tool to grip the pulling device, and wherein said insulator guide comprises a slit and is dimensioned and configured for performing as an insulator guide.
